(19) United States
(12) Patent Application Publication
(10) Pub. No.: US 2014/0248546 A1
(43) Pub. Date: Sep. 4, 2014

(54) HYDROGEN GENERATOR FOR A FUEL CELL

(71) Applicant: INTELLIGENT ENERGY, INC., San Jose, CA (US)

(72) Inventors: Russell H. BARTON, New Westminister (CA); Olen VANDERLEEDEN, Port Moody (CA); Guanghong ZHENG, Westlake, OH (US)

(73) Assignee: INTELLIGENT ENERGY, INC., San Jose, CA (US)

(21) Appl. No.: 14/279,623

(22) Filed: May 16, 2014

Related U.S. Application Data
(63) Continuation of application No. PCT/US2012/064595, filed on Nov. 12, 2012.
(60) Provisional application No. 61/560,444, filed on Nov. 16, 2011.

(51) Int. Cl. H01M 8/06; H01M 8/04; C01B 3/02

(52) U.S. Cl. CPC H01M 8/065; C01B 3/02; H01M 8/04746; H01M 8/04858
USPC 429/421; 422/198

(57) ABSTRACT

A hydrogen generator includes a housing, a pellet strip with a plurality of pellets disposed on a flexible carrier, the pellets including a hydrogen containing material that will release hydrogen gas when heated. A feed system feeds the pellet strip to sequentially position one or more pellets in proximity to a heater that heats the pellets to release hydrogen gas. The pellet strip can be folded or wound on a reel, stored in a compartment in the hydrogen generator or in a user-replaceable container. The hydrogen generator can be part of a fuel cell system that includes the hydrogen generator and a fuel cell battery.

### TECHNICAL FIELD

This disclosure relates to a hydrogen generator for providing hydrogen gas to a fuel cell, and a fuel cell system including the hydrogen generator and the fuel cell.

### BACKGROUND

Interest in fuel cell batteries as power sources for portable electronic devices has grown. A fuel cell is an electrochemical cell that uses materials from outside the cell as the active materials for the positive and negative electrode. Because a fuel cell does not have to contain all of the active materials used to generate electricity, the fuel cell can be made with a small volume relative to the amount of electrical energy produced compared to other types of batteries.

Fuel cells can be categorized according to the type of electrolyte used, typically one of five types: proton exchange membrane fuel cell (PEMFC), alkaline fuel cell (AFC), phosphoric-acid fuel cell (PAFC), solid oxide fuel cell (SOFC) and molten carbonate fuel cell (MCFC). Each of these types of fuel cell can use hydrogen and oxygen as the active materials of the fuel cell negative electrode (anode) and positive electrode (cathode), respectively. Hydrogen is oxidized at the negative electrode, and oxygen is reduced at the positive electrode. Ions pass through an electrically nonconductive, ion permeable separator and electrons pass through an external circuit to provide an electric current.

In some types of hydrogen fuel cells, hydrogen is formed from a hydrogen-containing fuel supplied to the negative electrode side of the fuel cell. In other types of hydrogen fuel cells, hydrogen gas is supplied to the fuel cell from a source outside the fuel cell.

A fuel cell system can include a fuel cell battery, including one or more fuel cells (a fuel cell battery), and a gas source, such as a gas tank or a gas generator. Gas generators that supply gas to a fuel cell can be an integral part of a fuel cell system, they can be removably coupled to the fuel cell system, or they can include replaceable components containing reactants. A removable gas generator can be replaced with another one when the gas producing reactants have been consumed. Removable gas generators can be disposable (intended for only a one-time use) or refillable (intended for use multiple times) to replace consumed reactant materials.

Hydrogen generators can produce hydrogen using a variety of reactants and a variety of methods for initiating the hydrogen generating reactants. Hydrogen gas can be evolved when a hydrogen containing material reacts. Examples of hydrogen containing materials include liquid or gaseous hydrocarbons (such as methanol), hydrides (such as metal hydrides and chemical hydrides), alkali metal silicides, metal/silica gels, water, alcohols, dilute acids and organic fuels (such as N-ethylcarbazone and perhydrofluorene). A hydrogen containing compound can react with another reactant to produce hydrogen gas, when the reactants are mixed together, in the presence of a catalyst, heat or an acid, or a combination thereof. A hydrogen containing compound can be heated to evolve hydrogen in a thermochemical decomposition reaction.

In selecting reactants for use in a hydrogen generator, consideration may be given to the following: (a) stability during long periods of time when the hydrogen generator is not in use, (b) ease of initiation of a hydrogen generating reaction, (c) the amount of energy that must be provided to sustain the hydrogen generating reaction, (d) the maximum operating temperature of the hydrogen generating reaction, and (e) the total volume of hydrogen that can be produced per unit of volume and per unit of mass of the reactant(s).

In order to provide hydrogen over a long period of time without developing a very high pressure within the hydrogen generator, it is desirable to generate the hydrogen on an as-needed basis. This requires controlling the reaction of the reactant(s), such as by reacting only a limited quantity at a time.

An object of the present invention is to provide a hydrogen generator with one or more of the following features: capable of producing a large total volume of hydrogen gas per unit of mass and per unit of volume of the hydrogen generator, capable of controlling the release of hydrogen gas from a hydrogen containing material to provide hydrogen on an as needed basis without producing an excessive internal pressure within the hydrogen generator, able to operate at or below a desired maximum temperature, all or a portion of the hydrogen generator in a fuel cell system can be replaced after the hydrogen containing materials have been consumed, long term durability and reliability, and easy and economic manufacturing.

### SUMMARY

In some aspects of some exemplary implementations of the invention, there is provided a hydrogen generating apparatus that includes a hydrogen generator including a housing; a pellet strip including a flexible carrier and a plurality of pellets disposed on the carrier, each pellet including a hydrogen—containing material that will release hydrogen gas when heated; an ignition system comprising a heater; and a feed system configured to feed the pellet strip to sequentially position one or more pellets in proximity to the heater such that the heater is capable of heating the proximal pellet to release hydrogen gas. Embodiments can include one or more of the following features:
the pellet strip is wound on a reel disposed within the housing;
the hydrogen generator includes a plurality of pellet strips; the plurality of pellet strips can be disposed on a single reel, or at least one pellet strip can be disposed on each of a plurality of reels;
the pellet strip is in a folded configuration, preferably in a Z-fold pattern;
the pellets disposed on one section of the carrier are nested between the pellets disposed on another section of the carrier;
the hydrogen generator includes a plurality of pellet strips;
the carrier is in the form of a strip with surfaces on opposite sides thereof; the pellets can be disposed on one of the surfaces of the carrier, or the pellets can be disposed on both surfaces of the carrier; the pellets can be disposed in a linear array along the carrier; the pellets can be disposed in a plurality of linear arrays along the carrier;
the pellet strip is disposed in a storage compartment within the housing;
the hydrogen generator comprises a plurality of storage compartments within the housing, each configured to contain at least one pellet strip; each compartment can have a feed system configured to feed the at least one pellet strip therein;
the storage compartment is defined by a moveable wall; the moveable wall can be moveable to reduce the size of the storage compartment as the carrier and pellets are fed by the feed system; the moveable wall can separate the storage compartment from a waste compartment within the housing; a portion of the feed system can be moveable together with the moveable wall;
the feed system includes a sprocket that cooperates with the pellets disposed on the carrier; the sprocket can be an indexing sprocket; the feed system can include a ratchet configured to allow the carrier to be advanced in only one direction; the feed system can include a bellows that engages an escapement to rotate the sprocket;
the ignition system includes more than one heater;
the pellet strip is contained in a user-replaceable container;
each pellet includes at least one hydrogen containing material; and
the pellet includes an ignition material.

In some aspects of some exemplary implementations another aspect of the invention, there is provided a fuel cell system including a fuel cell battery and a the hydrogen generator as described above. Embodiments can include one or more of the following features:
the fuel cell system further includes a control system configured to control the ignition system and the feed system based on at least one of a pressure within the fuel cell system, an electrical characteristic of the fuel cell battery, or an electrical characteristic of an electronic device in electrical communication with the fuel cell system; the control system can include at least one of a microprocessor, a micro controller; digital circuitry, analog circuitry hydrid digital and analog circuitry; a switching device; a capacitor, and sensing instrumentation.

### BRIEF DESCRIPTION OF THE DRAWINGS

In the drawings:

FIG. 1 is a cross-sectional view of a hydrogen generating cartridge according to an embodiment of the present invention;

FIG. 2 is a perspective view of a hydrogen generating cartridge according to an embodiment of the present invention; and

FIG. 3 is a perspective view of an embodiment of the hydrogen generating cartridge shown in FIG. 2.

### DETAILED DESCRIPTION

The present disclosure is directed to a hydrogen generator and a fuel cell system including the hydrogen generator and a fuel cell battery. The hydrogen generator is a hydrogen gas generating apparatus that releases hydrogen gas that is consumed by the fuel cell battery to produce electricity for an electronic device. The hydrogen generator includes a housing, a hydrogen containing material that will release hydrogen gas when heated, an ignition system including a heater to heat the hydrogen containing material, and a feed system. The hydrogen containing material is contained in a solid composition that is present in the form of a plurality of pellets disposed on a carrier. As used herein, “pellet” means a mass of a solid composition that includes a hydrogen containing material from which a release of hydrogen gas is initiated by heating. The feed system is configured to feed the carrier so individual pellets or groups of pellets are sequentially positioned in proximity to the heater, which can heat the pellets to initiate their thermal decomposition and evolve hydrogen gas.

The pellets can be of any suitable size and shape. They can be sized and shaped to fit into the housing in a volume-efficient manner. For example, the pellets can be in the shape of round, oval or prismatic (e.g., trapezoidal, rectangular or square) pills, tablets, wafers or cakes. The pellet size and composition can be chosen to provide a desired quantity of hydrogen from each pellet, based on the size of the fuel cell battery and the power requirements of the electronic device, for example. The pellets can be formed in various ways. They can be deposited (e.g., by coating, printing or otherwise applying), or be formed (e.g., by molding or shaping) and secured (e.g., by adhering, fastening or the like) onto one or both surfaces of a carrier (e.g., in the form of a strip, ribbon, belt, sheet, string or the like). As used herein, “strip” is intended to include any such carrier configuration.

The pellets contain at least one hydrogen containing material. More than one hydrogen containing material can be included. Examples include materials that can reversibly absorb and desorb hydrogen (e.g., metal-organic frameworks (MOFs), zeolites, graphene, carbon nanotubes and metal hydrides as AB₅ and AB₂ type hydrogen storage alloys such as titanium-manganese, mischmetal-nickel, lanthanum-nickel-cobalt and lanthanum-nickel alloys), materials that can react to produce hydrogen gas upon thermal decomposition (e.g., metal hydrides such as lithium hydride, magnesium hydride, and aluminum hydride (alane), complex hydrides and their ammonia adducts such as lithium borohydride, sodium borohydride, magnesium borohydride, calcium borohydride, ammine titanium (III) borohydride, lithium aluminum hydride, sodium aluminum hydride, lithium amide, and calcium aluminum hydride, and B—N chemical hydrides such ammonia borane and hydrazine borane), and various combinations including the above materials.

The pellets can also contain one or more additives. Examples of additives include binders (e.g., acrylates and styrene block copolymers), stabilizing compounds (e.g., solid bases), reaction accelerators (e.g., solid acids), catalysts (e.g., Fe₂O₃, TiCl₃), ignition materials as described below, thermally conductive materials (e.g., metals, graphites and combinations and composites thereof), and so on.

The carrier strip is sufficiently flexible to be fed by the feed system. The carrier including the pellets (i.e., the pellet strip) can be loaded into the housing in a rolled, folded or other configuration. In one embodiment a pellet strip is wound on a reel. More than one pellet strip can be disposed on a single reel, or one or more pellet strips can be disposed on separate reels. In another embodiment a pellet strip is folded in a Z-fold pattern (i.e., with alternating folds in opposite directions to create a stack of multiple layers of the pellet strip). The pellet strip can be disposed in a storage compartment within the housing, or the pellet strip can be disposed in a separate container that can be loaded into or attached to the housing. The hydrogen generator can be configured to contain one or more pellet strips, such as with at least one pellet strip in each of a plurality of compartments or containers, each of which can have a separate feed system. Pellets can be disposed on the carrier and the pellet strip can be disposed in such a manner as to facilitate feeding and provide a high density of pellets within the hydrogen generator. For example, the pellets can be disposed in one or more linear arrays along the carrier, or the pellet strip can be arranged so that pellets on one section of the carrier are nested between pellets on another section of the carrier.

To prevent the transfer of heat from one pellet to adjacent pellets on the carrier, which could result in an uncontrolled initiation of the release of hydrogen gas from adjacent pellets, the carrier can be a material that is not a good conductor of heat. The carrier can be made from a material that does not react substantially during the release of hydrogen gas from the hydrogen containing material. This has the advantage of not generating any reaction products that might interfere with the functioning of the hydrogen generator or that would have to be removed from the hydrogen gas before being used by the fuel cell battery. Alternatively, the carrier can be made from a material that does react during the release of hydrogen gas, e.g., by burning. This can eliminate the need to collect and store the carrier after the pellets have been consumed. Examples of materials that can be suitable as carrier materials include polyimides such as KAPTON® from E.I. duPont de Nemours; polypropylene such as SCLAIR® from Nova Chemicals (International) (Switzerland); TEFLON®, TEFZEL® and MYLAR® from E.I. duPont de Nemours; and paper.

While it may be desirable to release hydrogen gas from more than one pellet at a time, in order to prevent the uncontrolled initiation of adjacent pellets, it is desirable for individual pellets or groups of pellets to be thermally insulated from one another. This can be accomplished in various ways, including the use of a carrier material that is a poor conductor of heat, spacing the pellets apart from one another, placing thermal insulation on the carrier between adjacent pellets, coating portions of the pellets with thermally insulating materials, and so on. Suitable thermal insulator materials include silica, silicon dioxide, silicon nitrides, silican carbide, glass, and polymers such as polyimides and epoxy-amine composites.

A feed system feeds the pellet strip to sequentially position pellets, either individually or in groups, in proximity to the heater(s). Various types of feed systems can be used, such as augers, sprockets, ratchet wheels and rotating belts. In one embodiment the feed system includes a sprocket. For example, teeth on the sprocket can engage or create perforations or indentations along the carrier to feed the pellet strip as the sprocket rotates (e.g., in a manner similar to that of a movie projector feeding film). In another example, the pellets and spaces between them function like the links of a chain that is driven by a sprocket. The feed system can include an indexing mechanism for indexing the pellet strip in increments. An example of an indexing mechanism is a ratchet, which will only allow movement of the drive mechanism in one direction. A ratchet may be mounted on a sprocket, for example.

The ignition system heater heats one or more pellets positioned in proximity to the heater, resulting in a release of hydrogen gas from the hydrogen containing material in the pellet(s). The ignition system can include more than one heater. Multiple heaters can be advantageous when a single heater does not produce sufficient heat, when more than one pellet is to be ignited at one time, and when the hydrogen generator uses more than one pellet strip for example. Various types of heaters can be used. Examples include resistive heaters, infrared heaters, laser heaters, microwave heaters, semiconductor bridges and so on.

Alternatively, heating elements can be incorporated into the pellets or into the carrier. Electrical leads from the ignition system can make contact with heating element contacts so current to heat the heating elements is provided when the pellets are positioned in the desired location.

One or more pellets are positioned in close enough proximity to the heater(s) for the heater(s) to heat the pellet(s) sufficiently that the hydrogen containing material releases hydrogen gas. These “proximal” pellets may be spaced apart from the heater(s), or they may make contact with the heater(s).

The heater can heat the hydrogen containing material directly, or it can heat an ignition material (a material that will react exothermally, producing the heat necessary for the release of hydrogen gas from the hydrogen containing material). If the heater initiates release of hydrogen gas from the hydrogen containing material directly, the heater may provide heat only long enough to start the release, if the release is self-sustaining, or it may continue to provide heat for the entire time. If an ignition material is used, the ignition material can be disposed within or in contact with a pellet, the ignition material can be a separate layer of the pellet (i.e., separate from a layer containing the hydrogen containing material), or the ignition material can be mixed with the hydrogen containing material.

Examples of ignition materials (some of which can also contribute to the hydrogen yield) include metal/metal oxide multilayers such as Ti/Pb₃O₄, Zr/Fe₂O₃, guanidinium borohydride, B—N compounds blended with oxidizers such as ammonium nitrate or Sr(N0₃)₂ as described in US201110027168A1, metal/metal multilayered thin films and structures such as Ni/Al as described in U.S. Pat. No. 7,867,441, autoignition compositions such as silver nitrate mixed with potassium nitrate and molybdenum metal as described in U.S. Pat. No. 6,749,702, complex hydride, oxidizer, and S compositions such as described in U.S. Pat. No. 7,964,111, and the compositions described in patents US2008/0236032A1 and US 2008/0241613A1. Other compositions include gels of metals and water such as Mg/water/poly(acrylamide-co-acrylic acid) alone or in combination with sodium borohydride (Varma, et al. Chem. Eng. Sci 2010, 65, 80-87 and Int. J. Hydrogen En 2007, 32, 207-211, respectively).

The hydrogen generator can include a waste zone for accumulating decomposing pellets, spent pellets and any residue (e.g., carrier material, ashes or other reaction or combustion byproducts) from the pellet strip. The waste zone can be separated from the pellet strip storage compartment by a wall. The wall can be a moving wall that defines a portion of the storage compartment. The wall can move as the pellet strip is consumed, thereby reducing the size of the storage compartment and increasing the size of the waste area. If the hydrogen generator includes more than one storage compartment, it can include a waste zone for the pellet strip in each compartment, or a single waste zone can be associated with more than one storage compartment. When the storage compartment is defined by a moveable wall, a portion of the feed system (e.g., a feed sprocket) can be moveable together with the moveable wall.

Operation of the feed system, the ignition system or both can be controlled in various ways. A control system can be used. The control system can determine the need for hydrogen by monitoring the pressure within the fuel cell system, one or more electrical characteristics of the fuel cell battery, or one or more electrical characteristics of the electronic device, for example. The controller may communicate with the device or the fuel cell battery to determine when more hydrogen is needed. The control system can be completely or partially disposed in the hydrogen generator, the fuel cell battery, the electronic device being powered by the fuel cell battery, or any combination thereof The control system can include a microprocessor or micro controller; digital, analog and/or hydrid circuitry; solid state and/or electromechanical switching devices; capacitors, sensing instrumentation, and so on.

The housing of the hydrogen generator is made of a material that will withstand the heat and internal pressure that are produced to maintain desired dimensions and an adequate hydrogen seal. Examples of materials that may be suitable include metals such as aluminum and steel and polymeric materials such as polyphenylene sulfide and acrylonitrile butadiene styrene.

The hydrogen generator can include various filters and/or purification units to remove undesired byproducts and other contaminants from the hydrogen gas.

The hydrogen generator can also include various fittings, valves and electrical connections for providing hydrogen to and interfacing with the fuel cell battery and/or an electrical appliance being provided with power by the fuel cell system.

The hydrogen generator can include various safety features such as a pressure relief vent to release excessive pressure and a mechanism to stop the feeding of pellets to the ignition system if the internal temperature exceeds an established limit.

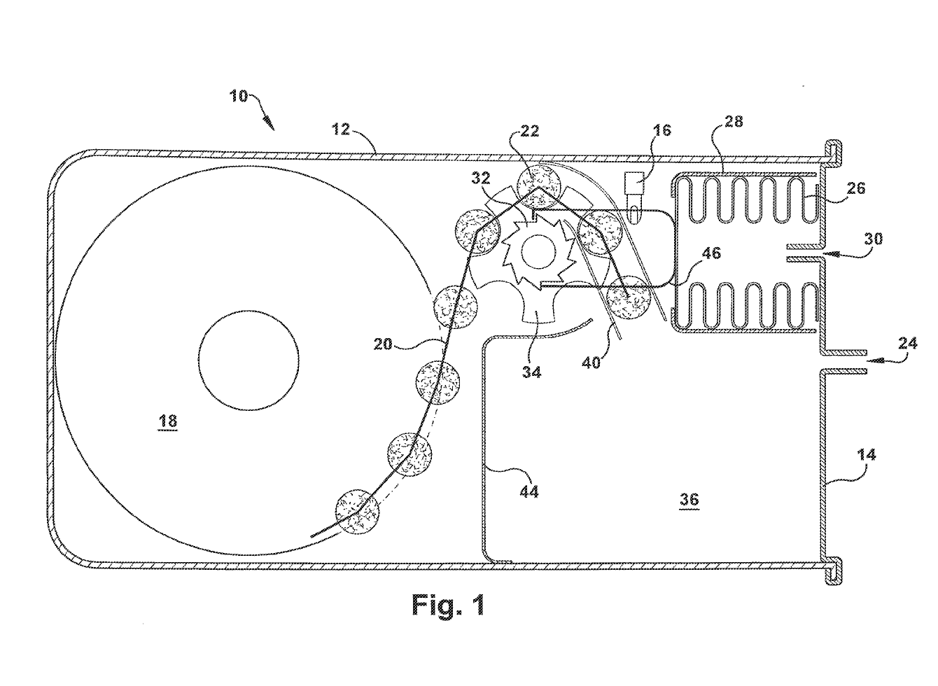

FIG. 1 illustrates an embodiment of a hydrogen generator. The hydrogen generator in this embodiment includes a cartridge 10 with a housing 12 and a lid 14. The hydrogen gas generated by the cartridge 10 is supplied to the fuel cell battery (not shown) via gas outlet 24. Within the housing 12 is a reel 18 onto which are wound a plurality of hydrogen generating pellets 22. The pellets 22 are connected to a carrier 20. Each pellet 22 is composed of solid composition that includes a hydrogen containing material that can release hydrogen gas when heated.

The reel of pellets is pulled onto a sprocket 34 by the action of a bellows 26 on a ratchet wheel 32. The bellows 26 has a flexible chamber that expands and contracts with the differential pressure inside and outside of the housing 12. Inside of the bellows 26 is a coil spring (not shown) such that if the pressure within the housing 12 is not greater than the pressure outside of the housing 12, the bellows 26 is at its relaxed extended length. The inside of bellows 26 is vented to the outside by bellows vent 30. A jacket 28 at least partially surrounds bellows 26. The bellows 26 is attached to an escapement 46 that rotates the ratchet wheel 32 and the feed sprocket 34 upon pressurization and again on depressurization. In one embodiment, the feed sprocket 34 contains 5 teeth, and the bellows 26 rotates the ratchet wheel 32 and the feed sprocket 34 by 1/10 of a turn on pressurization and another 1/10 of a turn on depressurization. Alternatively, other feed systems can be used.

In the relaxed, low pressure position of the cartridge 10, a pellet 22 is located adjacent to the heater 16. Upon activation of the heater 16, the pressure increase can rotate the sprocket 34, so that the decomposing pellet 22 does not remain adjacent the ignitor 16. A guide 40 can be included to lift the decomposing pellet 22 off of the feed sprocket 34, to prevent the feed sprocket from getting too hot.

In one embodiment, heater 16 is fabricated from a loop of nichrome wire welded to the copper secondary winding of a small transformer. The secondary voltage may be about ¼ to ½ VAC, with a current of about 6 amps. Other types of heaters, such as those described above, can be used.

As an alternative to the heater 16 shown in FIG. 1, individual heating elements can be incorporated into individual pellets 22 or into the carrier 20 in proximity to each pellet 22. When a pellet 22 is positioned such that electrical leads make contact with heating element electrical contact, electrical current is provided to heat the heating element.

As the hydrogen gas that is generated is used by the fuel cell battery, the pressure within the cartridge 10 falls, which causes the feed sprocket 34 to rotate and bring the next fuel pellet 22 adjacent the ignitor 16, which has now sufficiently cooled so as to not ignite the pellet 22 before hydrogen gas is needed. If the fuel cell system is still operating, the falling gas pressure within the fuel cell system can close a pressure switch of the fuel cell system, which will then tum on power to the heater 16 for heating the next fuel pellet 22 to repeat the process.

Each fuel pellet 22 can be addressed individually, which can allow careful control of hydrogen generation. In instances where a low flow rate of hydrogen is needed, one pellet 22 at a time may be heated and allowed to fully decompose before heating the next pellet 22. In instances where a high flow rate of hydrogen is needed, the pellets 22 may be heated in rapid succession, and/or more than one heater 16 may be used.

The decomposing or spent pellets 22 are directed into waste zone 36. A guide 40 can be used for this purpose. The carrier 20 that connects the pellets 22 together can burn, releasing the spent pellets 22, or the used carrier 20 and spent pellets 22 can accumulate in the waste zone 36. A jacket 28 can protect bellows 26 from any cinders produced by the decomposing pellets 22.

Waste zone 36 can be separated by wall 44 from the portion of the cartridge 10 in which the reel 18 of fresh pellets 22 is mounted. The wall 44 can be stationary, or it can be moveable. A moveable wall 44 can move to reduce the size of the compartment containing the pellet strip and increase the size of the waste zone 36 as the pellet strip is consumed. In some embodiments the sprocket 34 can move as the moveable wall 44 moves.

The entire interior volume of the housing 12 may be used as a gas reservoir for the hydrogen generated by the decomposition of the one or more pellets 22. Thus the volume of each pellet 22, the volume of the housing 12 and the maximum working pressure of the cartridge 10 are interrelated.

In one embodiment a fuel cell system includes a 20 watt fuel cell battery and a hydrogen generator using a lane as the hydrogen containing material. The hydrogen generator can decompose up to about 0.25 grams of alane per minute to provide hydrogen at a sufficient rate. This is equivalent to about 185 mm³ of pure alane with 90 percent solid packing, and will produce a total of about 300 cm³ of hydrogen gas per minute. The hydrogen generator contains 240 pellets evenly spaced on a carrier about 2.5 m long, wound on a reel. Each pellet contains 0.123 g of alane and has a spherical shape with a diameter of about 5.6 mm and a volume of about 93 mm³ The hydrogen generator can decompose pellets at a rate of 2 per minute. Such a hydrogen generator is expected to have a capacity of 40 Wh and last for 2 hours at 20 W.

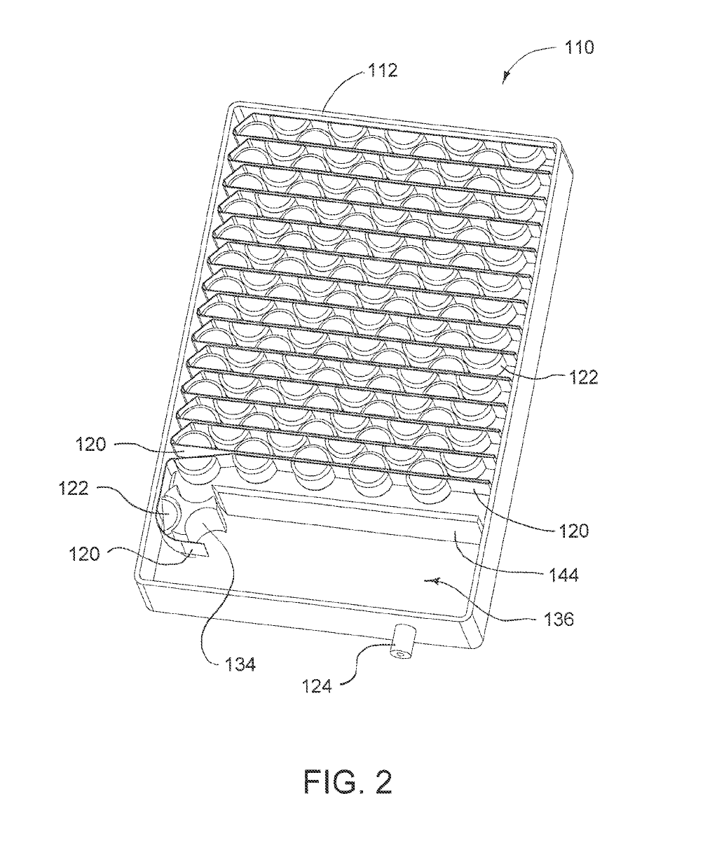

FIG. 2 illustrates aspects of some exemplary implementations of a hydrogen generator. The hydrogen generator includes a cartridge 110 with a housing 112 and a lid (not shown). The hydrogen gas generated by the cartridge 110 is supplied to the fuel cell battery (not shown) via a gas outlet 124. Within the housing 112 is a pellet strip with a plurality of hydrogen generating pellets 122 on a carrier 120. Each pellet 122 is composed of solid composition, such as those described above, that includes a hydrogen containing material that can release hydrogen gas when heated.

The pellet strip can be pulled by a sprocket 134. The sprocket 134 can be operated in a variety of ways. For example, the sprocket can be part of a feed system that includes an electric motor (not shown) that turns the sprocket 134 to advance the pellet strip. Alternatively, other feed systems, such as the feed system shown in FIG. 1 or another feed system can be used. The feed system can be controlled to advance pellets as more hydrogen is needed.

Pellets 122 are brought into contact or proximity with a heater. In FIG. 2 the heater is incorporated into the sprocket 134; however, a separate heater, e.g., one such as heater 16 in FIG. 1 or another type of heater can be used.

Each fuel pellet 122 can be addressed individually, which can allow careful control of hydrogen generation. In instances where a low flow rate of hydrogen is needed, one pellet 122 at a time may be heated and allowed to fully decompose before heating the next pellet 122. In instances where a high flow rate of hydrogen is needed, the pellets 122 may be heated in rapid succession. Multiple pellet strips, sprockets 134 and heaters can also be used.

As an alternative to the heater 16 shown in FIG. 1, individual heating elements can be incorporated into individual pellets 22 or into the carrier 20 in proximity to each pellet 22. When a pellet 22 is positioned such that electrical leads make contact with heating element electrical contact, electrical current is provided to heat the heating element.

The decomposing or spent pellets 122 are directed into waste zone 136. A guide (not shown) can be used for this purpose. The carrier 120 that connects the pellets 122 together can burn, releasing the spent pellets 122, or the used carrier 120 and spent pellets 122 can accumulate in the waste zone 136. (Note: spent pellets 122 and used carrier 120 are not shown in the waste zone 136 in FIG. 2.)

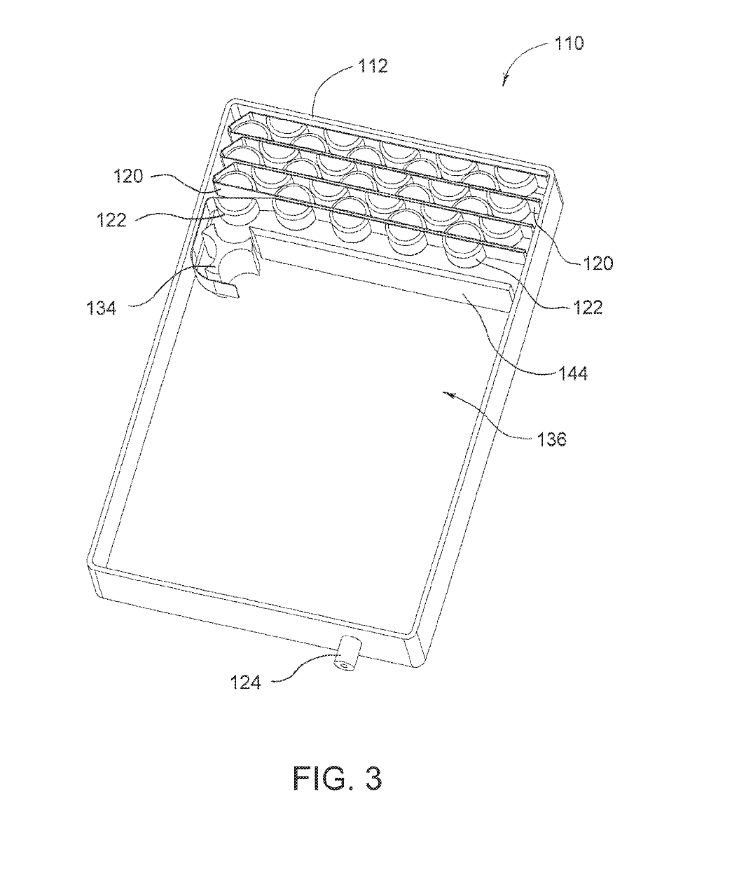

Waste zone 136 can be separated by wall 144 from the portion of the cartridge 110 in which the pellet strip of fresh pellets 122 is mounted. The wall 144 can be stationary, or it can move as portions of the pellet strip are consumed. A moving wall 144 can reduce the size of the compartment within which the pellet strip is contained and simultaneously increase the size of the adjacent waste zone 136. FIG. 3 shows an embodiment of the hydrogen generator 110 in FIG. 2, after a portion of the pellet strip has been used. In this embodiment the wall 144 is a moving wall, the size of the compartment containing the pellet strip has been reduced, and the size of the waste zone 136 has been enlarged.

The entire interior volume of the housing 112 may be used as a gas reservoir for the hydrogen generated by the decomposition of the one or more pellets 122. Thus the volume of each pellet 122, the volume of the housing 112 and the maximum working pressure of the cartridge 110 are interrelated.

What is claimed is:

1. A hydrogen generator comprising:
a housing;
a pellet strip comprising a flexible carrier and a plurality of pellets disposed on the carrier, each pellet comprising a hydrogen containing material that will release hydrogen gas when heated;
an ignition system comprising a heater;
a feed system configured to feed the pellet strip to sequentially position one or more pellets in proximity to the heater such that the heater is capable of heating the proximal pellet to release hydrogen gas.

2. The hydrogen generator of claim 1, wherein the pellet strip is wound on a reel disposed within the housing.

3. The hydrogen generator of claim 2, wherein the hydrogen generator comprises a plurality of pellet strips, and the plurality of pellet strips is disposed on a single reel.

4. The hydrogen generator of claim 3, wherein the hydrogen generator comprises a plurality of pellet strips and at least one pellet strip is disposed on each of a plurality of reels.

5. The hydrogen generator of claim 1, wherein the pellet strip is in a folded configuration, preferably in a Z-fold pattern.

6. The hydrogen generator of claim 1, wherein the pellets disposed on one section of the carrier are nested between the pellets disposed on another section of the carrier.

7. The hydrogen generator of claim 1, wherein the carrier is in the form of a strip with surfaces on opposite sides thereof

8. The hydrogen generator of claim 7, wherein the pellets are disposed on at least one of the surfaces of the carrier.

9. The hydrogen generator of claim 7, wherein the pellets are disposed on both surfaces of the carrier.

10. The hydrogen generator of claim 7, wherein the pellets are disposed in at least one linear array along the carrier.

11. The hydrogen generator of claim 10, wherein the pellets are disposed in a plurality of linear arrays along the carrier.

12. The hydrogen generator of claim 1, wherein the pellet strip is disposed in a storage compartment within the housing.

13. The hydrogen generator of claim 12, wherein the hydrogen generator comprises a plurality of storage compartments within the housing, each configured to contain at least one pellet strip.

14. The hydrogen generator of claim 13, wherein each compartment has a feed system configured to feed the at least one pellet strip therein.

15. The hydrogen generator of claim 14, wherein the storage compartment is defined by a moveable wall.

16. The hydrogen generator of claim 15, wherein the moveable wall separates the storage compartment from a waste compartment within the housing.

17. The hydrogen generator of claim 15, wherein a portion of the feed system is moveable together with the moveable wall.

18. The hydrogen generator of claim 1, wherein the feed system comprises a sprocket that cooperates with the pellets disposed on the carrier.

19. The hydrogen generator of claim 18, wherein the sprocket is an indexing sprocket.

20. The hydrogen generator of claim 18, wherein the feed system comprises a ratchet configured to allow the substrate to be advanced in only one direction.

21. The hydrogen generator of claim 18, wherein the feed system further comprises a bellows that engages an escapement to rotate the sprocket.

22. The hydrogen generator of claim 1, wherein the ignition system comprises more than one heater.

23. The hydrogen generator of claim 1, wherein each pellet comprises at least one hydrogen-containing reactant.

24. The hydrogen generator of claim 23, wherein the pellet comprises an ignition material.

25. A fuel cell system comprising:
a fuel cell stack; and
the hydrogen generator of claim 1.

26. The fuel cell system of claim 25, wherein the fuel cell system further comprises a control system configured to control the ignition system and the feed system based on at least one of a pressure within the fuel cell system, an electrical characteristic of the fuel cell stack, or an electrical characteristic of an electronic device in electrical communication with the fuel cell system.

27. The fuel cell system of claim 26, wherein the control system comprises at least one of a microprocessor, a micro controller; digital circuitry, analog circuitry hydrid digital and analog circuitry; a switching device; a capacitor, and sensing instrumentation.
